(19) United States
(12) Patent Application Publication
(10) Pub. No.: US 2014/0270318 A1
(43) Pub. Date: Sep. 18, 2014

(54) NECKLACE-TYPE AUDIO OUTPUT APPARATUS THAT CAN BE ADJUSTED IN LENGTH

(71) Applicant: Jae Joon Cho, Seoul (KR)

(72) Inventor: Jae Joon Cho, Seoul (KR)

(21) Appl. No.: 14/352,428

(22) PCT Filed: Jul. 5, 2012
(86) PCT No.: PCT/KR2012/005334

§ 371 Date: Apr. 17, 2014

(30) Foreign Application Priority Data
Oct. 18, 2011 (KR) 10-2011-0106337

(51) Int. Cl. H04R 1/02

(52) U.S. Cl. CPC H04R 1/02
USPC 381/385

(57) ABSTRACT

The present invention relates to a necklace-type audio output apparatus that can be adjusted in length, wherein the device comprises: an audio output device for externally outputting audio; a body on which the audio output device is installed; and an adjusting member connected to both ends of the body to form a ring shape together with the body, and capable of length adjustment. According to the present invention, by being worn around the neck of a user, the apparatus does not have to be worn directly on the ears. Thus, wearing discomfort and difficulty communicating due to blocked ambient noise are alleviated, length adjustment according to a user's physique or taste is made easy, and the apparatus can be safely and conveniently worn during exercise, hiking, cycling, and jogging.

### FIELD OF THE INVENTION

The present invention relates to adjustable necklace type audio output apparatus, and particularly, audio output apparatus wearable on neck of the user thereby avoiding direct contact to the ears thereby resolving any inconveniences and problem with communication that results from blocking ambient sound and provides length adjustment according to physical condition of the user.

### BACKGROUND ART

Generally, audio output apparatus that provides audio to individuals such as earphones, headphones, headsets and the like and are widely used. The aforementioned earphones, headphones and headsets are inserted or worn closely to the ears convert the electrical signal into audio signal to provide audio from portable audio devices or multimedia devices such as MP3 player, DMB, portable game consoles, PMP, mobile phones, net books and tablet computer.

Such personal audio output devices convert electrical signal into audio signal through built-in circuit, speaker used for output and jack for connecting to portable audio devices.

However, since conventional earphones and audio output devices including personal audio devices strain the ears as the audio signals are emitted directly into the ears. Moreover, it causes inconveniences that result from directly contacting the ears and causes accidents as people cannot hear any ambient noise. In particular, conventional earphones and audio output devices also cause inconvenience during exercise, hiking or cycling.

Furthermore, one of the problems is that it is hard to adjust the length of audio apparatus according to the physical condition or personal preference of the user.

### SUMMARY OF THE INVENTION

Accordingly, present invention has been made in view of the above mentioned problems occurring in the prior art, and it is an object of the present invention to provide audio output apparatus wearable on neck of the user that avoids direct contact to the ears thereby resolving any inconveniences and problem with communication that results from blocking ambient sound and provides length adjustment according to physical condition of the user as well as safe and convenient usage during exercise, hiking, cycling and jogging.

Other objectives of the invention will be disclosed through explanations regarding the embodiments below.

In order to achieve the above objectives, necklace type audio apparatus according to the embodiment of the present invention comprises of audio output device for output of the audio; body where audio output device is installed; and adjusting member that enables length adjustment which connects to the both ends of the body to form shape of the ring with the body that can slide for length adjustment from one end or both ends of the body and may further include fixing part that fastens the adjusting member as a detachable section on the side that adjusting member is attached on through sliding.

As for audio output device, it may refer to a device with exposed operation unit and speaker that plays the audio directly or by receiving wireless signals.

Audio output device may be in the form of computer, smart phone or one of the multimedia devices.

As for the body, it comprises of multiple numbers to be connected through adjustment member and may include audio output device or modules with divided audio output devices installed partly or wholly.

As for the fixing part, it is comprised of an opening that exposes the adjusting member and a quick lever installed on the opening as rotatable part that pressures or decreases the pressure of adjusting member according to the rotating angle.

Fixing part further comprises of unidirectional saw teeth formed along the longitude of adjusting member that hangs when it falls from the adjusting member; opening that formed in the body to expose the unidirectional saw teeth; latch that fastens to the opening as rotatable part and hangs or falls from the unidirectional saw teeth according to the rotating angle; and it may include the spring that provides elastic force for the latch to hang on to unidirectional saw teeth.

As for the body, it comprises of multiple forms to be connected by adjusting member where audio output device or modules with separate audio output devices may be partly or fully installed.

As for separated body, it can comprise of first and second connector that can connect to both ends which other separated body may connect to for providing electric signals to other separated body.

Separated body can be fastened with the hinge to each other through hinge structure.

### Advantageous Effects of Invention

Audio output apparatus wearable on neck of the user that avoids direct contact to the ears according to the present invention resolves any inconveniences and problem with communication that results from blocking ambient sound and provides length adjustment according to physical condition of the user as well as safe and convenient usage during exercise, hiking, cycling and jogging.

### BRIEF DESCRIPTION OF THE DRAWINGS

FIG. 1 is a perspective view of necklace type audio output apparatus that can be adjusted in length according to the first embodiment of the present invention.

FIG. 2 is a perspective view that explains how necklace type audio output apparatus that can be adjusted in length operates according to the first embodiment of the present invention.

FIG. 3 is a cross section view of necklace type audio output apparatus that can be adjusted in length according to the first embodiment of the present invention.

FIG. 4 is a cross section view of another example for necklace type audio output apparatus that can be adjusted in length according to the first embodiment of the present invention.

FIG. 5 is a perspective view of necklace type audio output apparatus that can be adjusted in length according to the second embodiment of the present invention.

FIG. 6 is a perspective view of necklace type audio output apparatus that can be adjusted in length according to the third embodiment of the present invention.

FIG. 7 is a cross section view of the body of necklace type audio output apparatus that can be adjusted in length according to the third embodiment of the present invention.

FIG. 8 is a perspective view of necklace type audio output apparatus that can be adjusted in length according to the fourth embodiment of the present invention.

FIG. 9 is an exploded view of the necklace type audio output apparatus that can be adjusted in length according to the fourth embodiment of the present invention.

FIG. 10 is a plan view of necklace type audio output apparatus that can be adjusted in length according to the fifth embodiment of the present invention.

### PREFERRED EMBODIMENTS OF THE INVENTION

Preferred features, embodiments and variations of the present invention may be discerned from the following detailed description and drawings. It is to be noted, however, that the appended drawings illustrate only typical embodiments of this invention and are therefore not to be considered limiting of its scope, for the invention may admit to other equally effective embodiments.

Hereinafter, embodiments according to the present invention will be described in detail and reference numeral of the same or corresponding components will be designated with same reference numerals in order to exclude duplicate explanations.

FIG. 1 is a perspective view of necklace type audio output apparatus that can be adjusted in length according to the first embodiment of the present invention.

As illustrated in FIG. 1, necklace type audio output apparatus 100 that can be adjusted in length according to the first embodiment of the present invention may include audio output device 110, body 120, 130 and adjusting member 140.

Audio output device 110 is the device that transmits audio and as an example, it can be a device that exposes speaker and operation unit from the body 120 and plays the audio directly or by receiving wireless signals. In other words, audio output device 110 can be mp3 player and radio that can directly transmit the audio or devices that receive audio signals by wireless communication to transmit audio through wireless communication module such as Blueteeth module from external DMB device, portable gaming device, PMP, mobile phone, net book, tablet computer and the like.

Body 120, 130 can have audio output device 110 installed internally and it is in multiple numbers in order to be connected to each other through adjusting member 140 according to the embodiment and may have audio output device 110 or modules with divided audio output devices 110 installed in part or whole. In other words, there can be two bodies 120, 130 as it is illustrated according to the embodiment or in multiple numbers connected to each other through adjusting member 140 and has audio output device 110 installed partly in the body 120 as illustrated according to the embodiment or module with divided audio output devices 110 such as control module with operation unit, speaker module that transmits audio, battery module that has batteries built in can all be installed in the body 120, 130 separately. Cable can be installed in the internal part of the adjusting member 140 to provide electrical signal and power for each of the modules for audio output device 110.

Body 120 where audio output device 110 is installed is provided with the cover 121 and operation unit hole 122 and speaker hole 123 in order for operation unit and the speaker of the audio output device 110 to be exposed. Earphone connector hole 124 can be put into place for earphone connector of the audio output device 110 to be exposed and furthermore, microphone hole (not illustrated) can be put into place to expose the microphone of the audio output device 110. Further, audio output device 110 can be equipped with battery or other power source for power supply or receive power from the battery mounting part that opens through the cover 131 which is part of the body 120, 130. Further, charging connector can be equipped on the body 120, 130 for charging the storage battery equipped on the audio output device 110 or the body 130.

Adjusting member 140 is connected to both ends of the body 120 to form circular, polygon or other different types of ring shapes with the body 120 in order for length adjustment to be possible. As illustrated in FIG. 2, it is combined through sliding to the one end of both ends of the body 120 for length adjustment to be possible. Adjusting member 140 can be made from rubber, silicon and other various synthetic resins that can be bent to some degree. Further, fixing part 150 that fastens the adjusting member as a detachable section may be provided on the body 140 at the side where adjusting member 140 is attached through sliding.

As illustrated in FIG. 3, fixing part 150 is installed in the opening 151 that exposes the adjusting member on the body 120 in order for it to rotate and can include a quick lever 152 that pressures or decreases the pressure of adjusting member 140. Quick lever 152 is exposed or protruded through the opening 151 for it to be rotatable by the user and can adjust the length of the adjusting member 140 as the pressure applied to the adjusting member 140 is controlled according to the deviation of the outer circumference and center of rotation. Further, As illustrated on FIG. 4, fixing part 160 comprises of unidirectional saw teeth 161 formed along the longitude of adjusting member 140 that hangs when it falls from the adjusting member 140, opening 162 that formed in the body 120 to expose the unidirectional saw teeth 161, latch 163 that fastens to the opening 162 so that it can be rotatable and hangs or falls from unidirectional saw teeth 161 according to the rotating angle and it may include the spring 164 that provides elastic force for the latch 163 to hang on to the unidirectional saw teeth 161.

### DESCRIPTION OF EMBODIMENTS

Hereinafter, various embodiments according to the present invention regarding necklace type audio output apparatus that can be adjusted in length will be described in detail and reference numeral of the same or corresponding components will be designated with same reference numerals in order to exclude duplicate explanations.

As illustrated in FIG. 5, necklace type audio output apparatus that can be adjusted in length according to the second embodiment of the present invention has unified body 210 in a curvature form where one end of adjusting member 220 is fixed to the end part and at the same time, another end of adjusting member 220 is combined to the other end and adjustable member 220 is fixed to the body 210 detachably through the fixing part 230. Thus, adjustable member 220 can form a shape of the ring with the body 210.

As illustrated in FIG. 6, one body 320 from one of the bodies 320, 330 of necklace type audio output apparatus that can be adjusted in length according to the third embodiment of the present invention is formed as multiple separated body 321, 322, 323 where they are combined as detachable parts and module with divided audio output devices 301 such as control module 311 and speaker module 312 with speaker can be installed in part or throughout the entire separated body 321, 322, 323. Thus, separated body 321, 322, 323 can be equipped with operation unit hole 324a, speaker hole 324b and earphone connector hole 325 for controlling and transmitting audio from the operation unit 311 and speaker module 312.

On the present embodiment, example of body 320, 330 in multiple forms where it is connected through adjusting member 340 and can fix or loosen the adjusting member 340 through fixing part 350. Further, power supply unit that supplies power to modules such as control module 311 and speaker module 312 is provided or power supply unit can be provided on the separated body 330. In the latter case, power can be supplied to the preferred module through power cable which is installed in the inner part of the adjustment member 340.

Each of the separated body 321, 322, 323 can be combined by shrink fit or by male and female screws as illustrated in FIG. 7. First and second connector 328a, 328b that can connect to each other is provided to supply power and electrical signal to separated body 321, 322, 323 for both sides where other separated body 321, 322, 323 are combined.

First and second connector 328a, 328b is provided in male and female and it can be connected to each other through shrink fit where end part is connected through cables 329 and multiple ends can be provided each for connection.

As illustrated in FIG. 8, adjusting member 420 comprises of multiple connecting parts 421 on both ends of the body 410 in one line as detachable parts and coupling structure 430 that combines the parts so that they can be separable which is located between the connecting parts 421 in the necklace type audio output apparatus 400 that can be adjusted in length according to the fourth embodiment of the present invention. Moreover, adjusting member 421 is connected to each other through the screws to adjust the length of adjusting member 420 and for this purpose, male screw 422 and female screw 423 for combining with the screw can be formed at both ends of the connecting part 421 and male screw part 411 and female screw part for connecting both ends of the body 421 through screws with the connecting part 421 as illustrated in FIG. 9. Connecting part 421 can be manufactured with rubber and other synthetic resins that are flexible.

Coupling structure 430 can comprise of link 431 and hook 432 that are combined to be detachable at the connecting part 421 that face each other according to the present embodiment. In another example, it can comprise of female and male buckle and can comprise of other combining methods.

As illustrated in FIG. 10, necklace type audio output apparatus 500 that can be adjusted in length according to the fifth embodiment of the present invention comprises of separated body 511 which is combined through adjusting member 530 and fastened through fixing part where one of the bodies 510 from the body 510, 520 is separable in multiple numbers as separated body 511 can be connected through the hinge through the hinge structure 512. Therefore, it is portable as separated body 511 is folded through hinge structure 512.

According to the present invention of necklace-type audio output apparatus that can be adjusted in length by being worn around the neck of a user, the apparatus does not have to be worn directly on the ears. Thus, wearing discomfort and difficulty communicating due to blocked ambient noise are alleviated, length adjustment according to a user's physique or taste is made easy, and the apparatus can be safely and conveniently worn during exercise, hiking, cycling, and jogging.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

[Description of Reference Numerals]

| | |
|---|---|
| 110: Audio output device | 120, 130: Body |
| 121, 131: Cover | 122: Operation unit hole |
| 123: Speaker hole | 124: Earphone connector hole |
| 140: Adjusting member | 150: Fixing part |
| 151: Opening | 152: Lever |
| 160: Fixing part | 163: Latch |

| | |
|---|---|
| 164: Spring | 210: Body |
| 220: Adjusting member | 230: Fixing part |
| 310: Audio output device | 311: Operating module |
| 321: Speaker module | 320, 330: Body |

| | |
|---|---|
| 321, 322, 323: Separated body | 324a: Operation unit hole |

| | |
|---|---|
| 324b: Speaker hole | 325: Earphone connector hole |
| 326: Male screw part | 327: Female screw part |
| 328a: First connector | 328b: Second connector |
| 329: Cable | 340: Adjusting member |
| 350: Fixing part | 410: Body |
| 411: Male screw part | 420: Adjusting member |
| 421: Connecting part | 422: Male screw part |
| 423: Female screw part | 430: Coupling structure |
| 431: Link | 432: Hook |
| 510, 520: Body | 511: Separated body |
| 512: Hinge structure | 530: Adjusting member |
| 540: Fixing part | |

1. A length-adjustable necklace type audio output apparatus comprising:
an audio output device for externally outputting audio;
a body in which the audio output device is installed; and
an adjusting member connected to both ends of the body to form a ring shape together with the body, and enabling length adjustment,
the adjusting member is slidably coupled to one end or both ends of the body so as to enable the length adjustment, and
on the side of the body to which the adjusting member is slidably coupled, the necklace type audio output apparatus further comprises a fixing part that releasably fix the adjusting member.

2. The length-adjustable necklace type audio output apparatus of claim 1 wherein the audio output apparatus device has a operation unit and a speaker each exposed from the body and directly plays the audio or plays the audio by receiving wireless signal.

3. The length-adjustable necklace type audio output apparatus of claim 1 wherein there are a plurality of the bodies connected to each other with the adjusting member, and installed in some or all of the bodies is the audio output device or modules into which the audio output device is divided.

4. The length-adjustable necklace type audio output apparatus of claim 1 wherein the fixing part comprises:
an opening formed in the body so as to expose the adjusting member; and
a quick lever that is rotatably installed in the opening and presses or releases the adjusting member depending on a rotation angle of the lever.

5. The length-adjustable necklace type audio output apparatus of claim 1 wherein the fixing part comprises:
unidirectional saw teeth formed on the adjusting member along a longitudinal direction thereof and enabling the adjusting member to be caught when the adjusting member is extracted;
an opening formed in the body so as to expose the unidirectional saw teeth;
a latch that rotatably coupled to the opening and caught to the unidirectional saw teeth or departing therefrom depending on rotation angle of the latch; and
a spring disposed in the opening to provide elastic force for the latch to be caught to the unidirectional saw teeth.

6. The length-adjustable necklace type audio output apparatus of claim 1 wherein the body consists of multiple division bodies that can be detachably coupled with each other, and disposed in some or all of the division bodies are modules into which the audio output device is divided.

7. The length-adjustable necklace type audio output apparatus of claim 6 wherein each of the division bodies are provided, on both ends thereof to which another division bodies coupled, with first and second connectors connectable with each other, for connection for transmission of electrical signal to another division bodies.

8. The length-adjustable necklace type audio output apparatus of claim 6 wherein the division bodies are hinge-coupled with each other by a hinge coupling unit.

9. The length-adjustable necklace type audio output apparatus of claim 1 wherein it is a computer, smart phone or a multimedia device.
